(19) United States
(12) Patent Application Publication
(10) Pub. No.: US 2024/0270931 A1
(43) Pub. Date: Aug. 15, 2024

(54) COMPOSITIONS COMPRISING POST-CONSUMER RECYLED RESIN AND ODOR-ACTIVE ZEOLITE TO MITIGATE TASTE AND ODOR

(71) Applicant: Dow Global Technologies LLC, Midland, MI (US)

(72) Inventors: Karlheinz Hausmann, Bachtobelstrasse (CH); Daniel G. Abebe, Lake Jackson, TX (US); Craig F. Gorin, Midland, MI (US); Carol Tsai, Lake Jackson, TX (US); Jin Wang, Mildand, MI (US); Scott T. Matteucci, Midland, MI (US); Kefu Sun, Lake Jackson, TX (US); Beata A. Kilos, Midland, MI (US)

(73) Assignee: Dow Global Technologies LLC, Midland, MI (US)

(21) Appl. No.: 18/567,188

(22) PCT Filed: Jun. 6, 2022
(86) PCT No.: PCT/US2022/032334

§ 371 Date: Dec. 5, 2023

Related U.S. Application Data
(60) Provisional application No. 63/197,552, filed on Jun. 7, 2021.

(51) Int. Cl. C08K 3/34; B01J 20/18; C08J 5/18; C08L 23/06

(52) U.S. Cl. CPC C08K 3/34; B01J 20/18; C08J 5/18; C08L 23/06; C08J 2323/06; C08J 2423/06; C08K 2003/343; C08K 2201/005; C08L 2205/025; C08L 2207/062; C08L 2207/20

(57) ABSTRACT

The present disclosure provides embodiments of a composition comprising post-consumer recycled resin comprising: at least 50 weight percent polyolefin, having an initial limonene level of at least 5 ppm; virgin ethylene-based polymer; and at least one odor-active zeolite, wherein the odor-active zeolite has an FAU crystal structure, an MFI crystal structure, and/or a beta crystal structure and a Si/Al molar ratio from 1 to 100, wherein the composition has a reduced limonene level of less than 3 ppm. The present disclosure also provides embodiments of a method of reducing taste and/or odor in a post-consumer recycled (PCR) resin-containing composition.

### CROSS-REFERENCE TO RELATED APPLICATIONS

This application claims the benefit of U.S. Provisional Application Ser. No. 63/197,552, filed Jun. 7, 2021, the entire disclosure of which is hereby incorporated herein by reference.

### TECHNICAL FIELD

Embodiments described herein generally relate to materials containing post-consumer recycled resin.

### BACKGROUND

Post-consumer recycled (PCR) material plays an increasingly larger role in environmental sustainability initiatives and efforts in today's world. PCR provides a way for industries to re-process and re-incorporate materials into consumer articles, which limits the consumption of new resources, permits the re-use of old materials, and sustainably creates the production of new articles. Plastic materials are susceptible to contaminants throughout their lifecycle, and as a consequence PCR materials often acquire undesirable taste and/or odor. The undesirable organoleptic properties of PCR materials presents challenges to industries striving to use PCR materials in effective ways, such as in consumer products including food and beverage containers. Volatile organic compounds, such as oxygenated compounds and limonene, contribute significantly to poor odor and/or taste properties of PCR materials. Typical processes employed to fabricate PCR resin-containing consumer products are not capable of sufficiently reducing the volatile organic compounds present in such resins.

Accordingly, there remains a need for PCR-containing materials that have organoleptic properties which are suitable for use in consumer products, such as for food and beverage containers.

### SUMMARY

Embodiments of the present disclosure meet those needs by providing a composition comprising a PCR resin of at least 50% weight polyolefin with an initial limonene level of at least 5 ppm; a virgin ethylene-based polymer; and at least one odor-active zeolite, wherein the odor-active zeolite has a beta, FAU, and/or MFI crystal structure and a Si/Al molar ratio from 1 to 100, wherein the composition has a reduced limonene level of less than 3 ppm.

Embodiments of the present disclosure are also directed to a method of reducing taste and/or odor in a post-consumer recycled (PCR) resin-containing composition, the method comprising: combining a PCR resin comprising at least 50 wt. % polyolefin and an initial limonene level of at least 5 ppm with a virgin ethylene-based polymer, and an odor-active zeolite having an FAU crystal structure, an MFI crystal structure, and/or a beta crystal structure and a Si/Al molar ratio from 1 to 100; and producing the PCR resin-containing composition having reduced taste and/or odor as well as a reduced limonene below 3 ppm by performing one or both of the following devolatilization steps: devolatilizing the PCR resin prior to the combining step; and devolatilizing the PCR-resin containing composition after the combining step.

Additional features and advantages of the embodiments will be set forth in the detailed description that follows, and in part will be readily apparent to those skilled in the art from that description or recognized by practicing the embodiments described herein, including the detailed description that follows, the claims, as well as the appended drawings.

It is to be understood that both the foregoing and the following description describes various embodiments and are intended to provide an overview or framework for understanding the nature and character of the claimed subject matter.

### DETAILED DESCRIPTION

Specific embodiments of the present application will now be described. These embodiments are provided so that this disclosure will be thorough and complete and will fully convey the scope of the subject matter to those skilled in the art.

As used herein, the terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The term “polymer” refers to a polymeric compound prepared by polymerizing monomers, whether of a same or a different type. The generic term polymer thus embraces the term “homopolymer,” which usually refers to a polymer prepared from only one type of monomer as well as “copolymer,” which refers to a polymer prepared from two or more different monomers, and “interpolymer.” Trace amounts of impurities (for example, catalyst residues) may be incorporated into and/or within the polymer. A polymer may be a single polymer or a polymer blend.

“Polyethylene” or “ethylene-based polymer” shall mean polymers comprising greater than 50% by mole of units derived from ethylene monomer. This includes ethylene-based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

As used herein, the term “LDPE” or “low density polyethylene” refers to an ethylene homopolymer prepared using a free radical. high-pressure (≥100 MPa (for example, 100-400 MPa)) polymerization. LDPE resins typically have a density in the range of 0.916 to 0.935 g/cm³.

The term “LLDPE” or “linear low density polyethylene includes resin made using Ziegler-Natta catalyst systems as well as resin made using single-site catalysts, including, but not limited to, bis-metallocene catalysts (sometimes referred to as “m-LLDPE”), phosphinimine, and constrained geometry catalysts, and resins made using post-metallocene, molecular catalysts, including, but not limited to, bis(biphenylphenoxy) catalysts (also referred to as polyvalent aryloxyether catalysts). LLDPE includes linear, substantially linear, or heterogeneous ethylene-based copolymers or homopolymers. LLDPEs contain less long chain branching than LDPEs and include the substantially linear ethylene polymers, which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and blends thereof (such as those disclosed in U.S. Pat. No. 3.914.342 and U.S. Pat. No. 5,854,045). The LLDPE resins can be made via gas-phase, solution-phase, or slurry polymerization or any combination thereof, using any type of reactor or reactor configuration known in the art.

The term “HDPE” or “high density polyethylene” refers to ethylene-based polymers having densities greater than 0.940 g/cc, which are generally prepared with Ziegler-Natta catalysts, chrome catalysts or even metallocene catalysts. The terms “pre-consumer recycled polymer” and “post-industrial recycled polymer” refer to polymers, including blends of polymers, recovered from pre-consumer material, as defined by ISO-14021. The generic term pre-consumer recycled polymer thus includes blends of polymers recovered from materials diverted from the waste stream during a manufacturing process. The generic term pre-consumer recycled polymer excludes the reutilization of materials, such as rework, regrind, or scrap, generated in a process and capable of being reclaimed within the same process that generated it.

Embodiments are directed to compositions comprising: post-consumer recycled (PCR) resin comprising at least 50 wt. % polyolefin, the PCR resin having an initial limonene level of at least 5 ppm; virgin ethylene-based polymer; and at least one odor-active zeolite, wherein the odor-active zeolite has an FAU crystal structure, an MFI crystal structure, and/or a beta crystal structure and a Si/Al molar ratio from 1 to 100, wherein the composition has a reduced limonene level of less than 3 ppm.

### PCR Resin

The term “post-consumer recycled resin” (or “PCR resin”), as used herein, refers to a polymeric material, including blends of polymers, recovered from materials previously used in a consumer or industry application, as defined by ISO-14021. The generic term post-consumer recycled resin thus includes blends of polymers recovered from materials generated by households or by commercial, industrial, and institutional facilities in their role as end-users of the material, which can no longer be used for its intended purpose. The generic term post-consumer recycled resin also includes blends of polymers recovered from returns of materials from the distribution chain. PCR resin is often collected from recycling programs and recycling plants. The PCR resin may include one or more of a polyethylene, a polypropylene, a polyester, a poly(vinyl chloride), a polystyrene, an acrylonitrile butadiene styrene, a polyamide, an ethylene vinyl alcohol, an ethylene vinyl acetate, or a poly-vinyl chloride. The PCR resin may include one or more contaminants. The contaminants may be the result of the polymeric material's use prior to being repurposed for reuse. For example, contaminants may include paper, ink, food residue, or other recycled materials in addition to the polymer, which may result from the recycling process.

PCR resin is distinct from virgin polymeric material. A virgin polymeric material does not include materials previously used in a consumer or industry application. Virgin polymeric material has not undergone, or otherwise has not been subject to, a heat process or a molding process other than the polymer synthesis process or pelletization, like a typical PCR resin. The physical, chemical, and flow properties of PCR resins differ when compared to virgin polymeric resin, which in turn can present challenges to incorporating PCR resin into formulations for commercial use.

PCR resin is typically polyolefin, and polyethylene in particular. PCR may be sourced from HDPE packaging such as bottles (milk jugs, juice containers), LDPE/LLDPE packaging such as films. PCR also includes residue from its original use, residue such as paper, adhesive, ink, nylon, ethylene vinyl alcohol (EVOH), polyethylene terephthalate (PET), and other odor-causing agents. Sources of PCR resin can include, for example, bottle caps and closures, milk, water or orange juice containers, detergent bottles, office automation equipment (printers, computers, copiers, etc.), white goods (refrigerators, washing machines, etc.), consumer electronics (televisions, video cassette recorders, stereos, etc.), automotive shredder residue (the mixed materials remaining after most of the metals have been sorted from shredded automobiles and other metal-rich products “shredded” by metal recyclers), packaging waste, household waste, rotomolded parts (kayaks/coolers), building waste and industrial molding and extrusion scrap.

PCR resin is typically polyolefin, and polyethylene in particular. PCR may be sourced from HDPE packaging such as bottles (milk jugs, juice containers), LDPE/LLDPE packaging such as films. PCR also includes residue from its original use, residue such as paper, adhesive, ink, nylon, ethylene vinyl alcohol (EVOH), polyethylene terephthalate (PET), and other odor-causing agents. Sources of PCR resin can include, for example, bottle caps and closures, milk, water or orange juice containers, detergent bottles, office automation equipment (printers, computers, copiers, etc.), white goods (refrigerators, washing machines, etc.), consumer electronics (televisions, video cassette recorders, stereos, etc.), automotive shredder residue (the mixed materials remaining after most of the metals have been sorted from shredded automobiles and other metal-rich products “shredded” by metal recyclers), packaging waste, household waste, rotomolded parts (kayaks/coolers), building waste and industrial molding and extrusion scrap.

In embodiments, the polyolefin in the PCR resin can be any polyolefin found in recycled streams. For example, high-density polyethylene (HDPE), low-density polyethylene (LDPE), linear low-density polyethylene (LLDPE), MDPE, ULDPE, polypropylene (PP), functionalized polyolefins and combinations of two or more of the preceding polymers.

In embodiments, the polyolefin in the PCR resin is a high-density polyethylene (HDPE)-based PCR resin having a density from 0.940 g/cc to 0.975 g/cc, or from 0.950 g/cc to 0.975 g/cc, or from 0.955 g/cc to 0.965 g/cc. Moreover, the HDPE PCR may have a melt index (I₂) of 0.1 to 2 g/10 mins, or from 0.2 to 1 g/10 mins as measured according to ASTM D1238 (190° C./2.16 kg).

In embodiments, the PCR resin further comprises residue from its original use, such as paper, adhesive, ink, nylon, ethylene vinyl alcohol (EVOH), polyamide (PA), polyethylene terephthalate (PET), and other organic or inorganic material.

In embodiments, the PCR resin comprises at least 50 weight percent (wt. %) or at least 60 weight percent, or at least 70 weight percent, or at least 75 weight percent, or at least 80 weight percent, or at least 85 weight percent, or at least 90 weight percent, or at least 95 weight percent, of a polyolefin based on total weight of the post-consumer recycled resin. In embodiments, the PCR resin can comprise up to 99.9 weight percent, or up to 99.5 weight percent, or up to 99 weight percent, or up to 98 weight percent, or up to 97 weight percent, or up to 96 weight percent, or up to 95 weight percent, or up to 90 weight percent, of polyolefin based on total weight of the post-consumer recycled resin.

In embodiments, the composition comprises from 15 to 95 weight percent (wt. %) of a PCR, based on the total wt. % of the composition. All individual values and subranges of from 15 wt. % to 95 wt. % are disclosed and included herein; for example, the composition can comprise from 15 to 95 wt. %, from 20 to 95 wt. %, from 25 to 95 wt. %, from 30 to 95 wt. %, from 35 to 95 wt. %, from 40 to 95 wt. %, from 45 to 95 wt. %, from 50 to 95 wt. %, from 55 to 95 wt. %, from 60 to 95 wt. %, from 65 to 95 wt. %, from 75 to 95 wt. %, from 80 to 95 wt. %, from 85 to 95 wt. %, from 90 to 95 wt. %, from 25 to 30 wt. %, from 25 to 35 wt. %, from 25 to 40 wt. %, from 25 to 45 wt. %, from 25 to 50 wt. %, from 25 to 55 wt. %, from 25 to 60 wt. %, from 25 to 65 wt. %, from 25 to 70 wt. %, from 25 to 75 wt. %, from 25 to 80 wt. %, from 25 to 85 wt. %, or from 25 to 90 wt. %, based on the total wt. % of the composition. In embodiments, the composition comprises from 60 to 80 wt. %, including all individual values and subranges from 60 to 80 wt. %.

In embodiments, the PCR resin comprises at least 50 weight percent (wt. %) of polyolefin, based on the total wt. % of the PCR resin. In embodiments, the PCR resin comprises at least 60 weight percent (wt. %) of polyolefin, based on the total wt. % of the PCR resin. In embodiments, the PCR resin comprises at least 70 weight percent (wt. %) of polyolefin, based on the total wt. % of the PCR resin. In embodiments, the PCR resin comprises at least 80 weight percent (wt. %) of polyolefin, based on the total wt. % of the PCR resin. In embodiments, the PCR resin comprises at least 90 weight percent (wt. %) of polyolefin, based on the total wt. % of the PCR resin. In aspects, the polyolefin is a polyethylene.

In aspects, the PCR resin include contaminants primarily arising from the article(s) from which the PCR resin is derived and the use(s) of such article(s). Examples of such contaminants include limonene, oxygenated (or “oxygenates”) (e.g., aldehydes, ketones, and THF-derivatives), hydrocarbons, non-olefin polymers, oxidized polyolefins, inorganic materials, adhesive materials, paper, oil residue, food residue, and combinations of two or more thereof.

The amount of contaminants can be at least 0.1. or at 0.5. or at least 1, or at least 2, or at least 3, or at least 4, or at least 5, or at least 10 weight percent of the PCR resin. The amount of contaminants can be up to 50, or up to 40, or up to 30, or up to 25, or up to 20, or up to 15, or up to 10, or up to 5 weight percent of total amount of contaminants based on total weight of the PCR resin. The higher amounts of contaminants can occur when the contaminants include other polymeric materials, such as, for example, nylons, polyesters (e.g. polyethylene terephthalate (PET), alkylene vinyl alcohols (e.g. ethylene vinyl alcohol (EVOH), etc.).

As used herein, the term “limonene” refers to a colorless, volatile, aliphatic hydrocarbon compound, specifically a cyclic monoterpene, which is a major component of the oil from citrus fruit peels, such as lemons and organs. Limonenes are frequently used as flavoring and coloring agents in food manufacturing and production of other household items, such as soaps and detergents. Limonenes have a prominent taste and odor. Limonenes are frequently adsorbed by plastic materials that contain them or otherwise come into contact with them, and are one of many contaminants present in PCR resins. The term “limonene,” as used herein, may refer 1-Methyl-4-(prop-1-en-2-yl)cyclohex-1-ene, as well as oxidized forms of limonene.

In embodiments, the PCR resin has an initial limonene level of at least 3 ppm, at least 4 ppm, at least 5 ppm, at least 6 ppm, at least 7 ppm, at least 8 ppm, at least 9 ppm, or at least 10 ppm. In further embodiments, the PCR resin has an initial limonene level of at least 5 ppm.

In embodiments, the PCR resin can have a Gel Index (200 microns) of at least 100, or at least 150 or at least 200, or at least 250 mm²/24.6 cm³ of sample. In embodiments, the PCR resin has a Gel Index (200 microns) of 267 mm²/24.6 cm³ of sample. A unit sample volume of, for example, 24.6 cm³ can be inspected in each gel measurement. The inspection can occur using a gel counter having a light source, a line scan camera (e.g. Optical Control System (OCS) FSA100 camera (25 um resolution)) and an imaging processor. The gel counter can be configured in transmission mode, with the film passing between the light source and the camera. The analysis can include illuminating the film sample with the light source. The camera can measure the intensity of the light transmitted through the film. Gels present in the film refract or block light reducing the amount of light reaching the camera. In this way, a digitalized image of the gel can be created. The area of the digitalized gel can be determined by summing the number of pixels and it includes. The diameter of the gel is assigned by calculating the diameter of a circle with equivalent area. A sample volume of, for example, 24.6 cm³ corresponds to an inspected area of 0.323 m², of a 76 micron thick film. The total area of all gels with diameter >200 micron is determined in each measurement. Fifty such measurements can be carried out. The average value of the total gel area is calculated based on the total number of measurements (e.g. 50), and expressed in mm² per volume of sample (e.g. 24.6 cubic centimeters sample) inspected.

### Virgin Ethylene-Based Polymer

A virgin polymeric material does not include materials previously used in a consumer or industry application. Virgin polymeric material has not undergone, or otherwise has not been subject to, a heat process or a molding process, like a typical PCR resin.

In embodiments, the present composition comprises a virgin ethylene-based polymer. The ethylene-based polymer may comprise one or more ethylene-based polymers as defined above. In one or more embodiments, the virgin ethylene-based polymer comprises HDPE having a density from 0.940 g/cc to 0.975 g/cc, or from 0.950 g/cc to 0.975 g/cc, or from 0.955 g/cc to 0.965 g/cc. Moreover, the HDPE may have a melt index (I₂) of 0.1 to 2 g/10 mins, or from 0.2 to 1 g/10 mins as measured according to ASTM D1238 (190° C./2.16 kg).

In embodiments, the composition comprises from 1 to 85 weight percent (wt. %) of a virgin ethylene-based polymer, based on the total wt. % of the composition. All individual values and subranges of from 1 to 85 wt. % are disclosed and included herein; for example, the composition can comprise from 5 to 75 wt. %, from 10 to 75 wt. %, from 15 to 75 wt. %, from 20 to 75 wt. %, from 25 to 75 wt. %, from 30 to 75 wt. %, from 40 to 75 wt. %, from 50 to 75 wt. %, from 60 to 75 wt. %, from 70 to 75 wt. %, from 5 to 10 wt. %, from 5 to 20 wt. %, from 5 to 30 wt. %, from 5 to 35 wt. %, from 5 to 40 wt. %, from 5 to 40 wt. %, from 5 to 50 wt. %, from 5 to 60 wt. %. from 5 to 70 wt. %, from 25 to 65 wt. %, from 25 to 70 wt. %. from 25 to 75 wt. %, from 25 to 80 wt. %, or from 25 to 85 wt. %, based on the total wt. % of the composition. In embodiments, the composition comprises from 20 to 40 wt. %, including all individual values and subranges of from 20 to 40 wt. %.

In embodiments, virgin polyolefin resin typically have a Gel Index (200 microns) of less than about 10 mm²/24.6 cm³ of sample. PCR polyolefins have a higher gel index than virgin polyolefins due to contamination and because the materials have been made into an article, used, and recovered. The processing means that the material has gone through at least two or at least three prior thermal cycles of heating and cooling.

### Odor Active Zeolite

As used herein, the term “zeolite” refers to microporous crystalline materials with well-defined structures of voids and channels of discrete sizes, and which are predominantly composed of aluminum, silicon, and oxygen (i.e., aluminosilicates) in their regular framework. Zeolites may additionally comprise various cations. Zeolites may be used as adsorbents and catalysts. Zeolites occur naturally, but may also be industrially produced on a large scale. Zeolites have a highly regular, crystal pore structure that have dimensions on a molecular scale. Due to their porosity, zeolites have a molecular sieve property, such that they are capable of sorting molecules based primarily on a size exclusion process. As used herein, the term “odor-active zeolite” refers to a zeolite that is an odor control agent, for example due to its capacity to absorb and/or adsorb odorous liquids and gases, thereby neutralizing odors.

Different zeolite species have different crystalline structures that determine the distribution, shape, and size of the zeolite's pores. Natural zeolites may crystallize in a variety of natural processes, while artificial zeolites may be crystallized, for example, from a silica-alumina gel in the presence of templates and alkalis. There are over 200 known types of zeolite crystal structures. A beta zeolite is a specific type of complex zeolite structure consisting of an intergrowth of polymorph A and polymorph B structures, which both contain a three-dimensional network of 12-membered ring pores, with sheets randomly alternating between polymorph A and polymorph B. An MFI crystal structure, which may also be referred to as a silicate-1 crystal structure, is a zeolite structure comprising multiple pentasil units connected by oxygen bridges which form pentasil chains, and having the chemical formula: NaₙAlₙSi₉₆₋ₙO₁₉₂·16H₂O, wherein n is greater than zero and less than 27. A faujasite (“FAU”) crystal structure, which may also be referred to a Y-type crystal structure or an IZA crystal structure, is a zeolite crystal structure that consists of sodalite cages which are tetrahedrally connected through hexagonal prisms, and which has a pore formed by a 12-membered ring.

In aspects, the composition comprises at least one odor-active zeolite, wherein the odor-active zeolite has a beta crystal structure, an FAU crystal structure, and/or an MFI crystal structure. In aspects, the odor-active zeolite has a mixture of crystal structures, wherein the mixture of crystal structures comprises one or more crystal structures selected from the group consisting of: a beta crystal structure, an FAU crystal structure, and an MFI crystal structure. In aspects, the composition comprises a zeolite having a mixture of crystal structures, wherein the mixture of crystal structures comprises an MFI crystal structure and an FAU crystal structure. In aspects, the composition comprises a zeolite that has a beta crystal structure (i.e., a beta zeolite). In aspects, the composition comprises a zeolite that has an FAU crystal structure. In aspects, the composition comprises a zeolite that has an MFI crystal structure.

Zeolites may be classified by the molar ratio of silicon to aluminum (“Si/Al molar ratio”) within the zeolite. In embodiments, the composition comprises a zeolite having an Si/Al molar ratio from 1 to 100. All individual values and subranges of a molar ratio from 1 to 100 are disclosed and included herein, including from 1 to 10, from 1 to 20, from 1 to 30, from 1 to 40, from 1 to 50, from 1 to 60, from 1 to 70, from 1 to 80, or from 1 to 90.

Zeolites may further be classified by its grain size. The grain size of a zeolite refers to the size of an individual zeolite crystal. In embodiments, the composition comprises a zeolite having a grain size of from 250 nm to 2 μm. All individual values and subranges of from 250 nm to 2 μm are disclosed and included herein; for example, the zeolite can have a grain size of from 250 nm to 2 μm, from 250 nm to 1 μm, from 250 nm to 750 nm, from 250 nm to 500 nm, from 500 nm to 2 μm, from 750 nm to 2 μm, or from 1 μm to 2 μm.

In embodiments, the composition comprises from 0.025 to 2.0 weight percent (wt. %) of at least one odor-active zeolite, based on the total wt. % of the composition. All individual values and subranges of from 0.025 wt. % to 2.0 wt. % are disclosed and included herein; for example, the composition can comprise from 0.025 wt. % to 1.0 wt. %, from 0.025 wt. % to 0.5 wt. %, from 0.025 wt. % to 0.1 wt. %, from 0.025 wt. % to 0.05 wt. %, from 0.05 wt. % to 2.0 wt. %, from 0.1 wt. % to 2.0 wt. %, from 0.5 wt. % to 2.0 wt. %, or from 1.0 wt. % to 2.0 wt. %, based on the total wt. % of the composition.

In aspects, the composition comprises at least one odor-active zeolite, wherein the odor-active zeolite has an FAU crystal structure, an MFI crystal structure, and/or a beta crystal structure and a Si/Al molar ratio from 1 to 100. In aspects, the composition comprises from 0.025 wt. % to 2.0 wt. % of the at least one odor active zeolite. In aspects, the at least one odor-active zeolite has a grain size of from 250 nm to 2 μm. In aspects, the Si/Al molar ratio of the at least one odor-active zeolite is from 1 to 50. In aspects, the Si/Al molar ratio of the at least one odor-active zeolite is from 1 to 20.

Various commercial embodiments are considered possible for the odor active zeolites. For example, suitable commercial embodiments of the least one odor-active zeolite are Abscents 2000 and Abscents 3000, which are both commercially available from UOP.

Due to the zeolites alone or in combination with devolatilization as described below, the initial limonene level of the PCR is reduced. In one or more embodiments, the reduced limonene level of the composition is less than 3 ppm. In embodiments, the reduced limonene level of the composition is less than 2.5 ppm. In embodiments, the reduced limonene level of the composition is less than 2.0 ppm. In embodiments, the reduced limonene level of the composition is less than 1.5 ppm. In embodiments, the reduced limonene level of the composition is less than 1.0 ppm. In embodiments, the reduced limonene level of the composition is less than 0.9 ppm. In embodiments, the reduced limonene level of the composition is less than 0.8 ppm. In embodiments, the reduced limonene level of the composition is less than 0.7 ppm. In embodiments, the reduced limonene level of the composition is less than 0.6 ppm. In embodiments, the reduced limonene level of the composition is less than 0.5 ppm. In embodiments, the reduced limonene level of the composition is not detectable.

As used herein, the term “oxygenates” and “oxygenated compounds” refers to compounds that contain oxygen in their chemical structure. Many oxygenates, including the oxygenates of interest in PCR resins, are volatile. Oxygenates include aldehydes, ketones, and THF-derivatives. Oxygenates, including the oxygenates of interest in PCR resins, can have a prominent taste and/or odor. Oxygenates are frequently contaminants of PCR resins.

In further aspects, the oxygenate level of a PCR resin-containing composition is reduced at least 75% relative to the initial PCR resin. In aspects, the oxygenate level of a PCR resin-containing composition is reduced at least 80% relative to the initial PCR resin. In aspects, the oxygenate level of a PCR resin-containing composition is reduced by at least 85% relative to the initial PCR resin. In aspects, the oxygenate level of a PCR resin-containing composition is reduced by at least 90% relative to the initial PCR resin. In aspects, the oxygenate level of a PCR resin-containing composition is reduced at least 95% relative to the initial PCR resin.

### Products

In embodiments, the present disclosure is directed to a product comprising the composition as disclosed herein. In aspects, the present disclosure is directed to a product comprising the composition as disclosed herein, wherein the product comprises a consumer product. In aspects, the present disclosure is directed to a product comprising the composition as disclosed herein, wherein the product comprises a food and/or beverage container. In aspects, the present disclosure is directed to a product comprising the composition as disclosed herein, wherein the product comprises a cap and/or a closure of a consumer product, such as a food and/or beverage container.

In embodiments, the present disclosure is directed to a product comprising the composition as disclosed herein, wherein the product comprises a film. In aspects, the present disclosure is directed to a product comprising the composition as disclosed herein, wherein the product comprises a monolayer film. In aspects, the present disclosure is directed to a product comprising the composition as disclosed herein, wherein the product comprises a multilayer film.

### Methods of Reducing Taste and/or Odor in a PCR Resin-Containing Composition

In embodiments, the present disclosure is directed to a method of reducing taste and/or odor in a PCR resin-containing composition in order to significantly reduce the amount of contaminants, such as volatile organic compounds (including oxygenated compounds (e.g., aldehydes, ketones, and THF-derivatives) and limonenes), by combining devolatilization technology with a molecular sieve technology to adsorb known oxygenates and limonenes that contribute to undesirable taste and/or odor.

In embodiments, the present disclosure is directed to a method of reducing taste and/or odor in a post-consumer recycled (PCR) resin-containing composition, the method comprising: combining a PCR resin comprising at least 50 wt. % polyolefin and an initial limonene level of at least 5 ppm with a virgin ethylene-based polymer, and an odor-active zeolite having an FAU crystal structure, an MFI crystal structure, and/or beta crystal structure and a Si/Al molar ratio from 1 to 100; and producing the PCR resin-containing composition having reduced taste and/or odor as well as a reduced limonene below 3 ppm by performing one or both of the following devolatilization steps: devolatilizing the PCR resin prior to the combining step; and devolatilizing the PCR-resin containing composition after the combining step.

As used herein, the term “devolatilization” refers to a process by which undesired volatile contaminants (e.g., dissolved gasses, solvent, unreacted monomer, etc.) are removed from a polymer melt or solution. The devolatilization process is driven by superheating the volatile component of the polymer melt/solution, then subsequently exposing the melt/solution to a rapid decompression. Devolatilization may be performed on screw extruders, including single-screw or multi-screw extruders. As used herein, “twin-screw extruder” refers to an extruder have two screws. The two screws in a twin-screw extruder may be co-rotating (i.e., rotating in the same direction) or counter-rotating (i.e., rotating in opposite directions). A typical devolatilization zone in a screw extruder consists of a portion of a screw that is partially filled, isolated by two sections that are filled with melt/solution.

In aspects, the devolatilization step of the present method is performed on a twin-screw extruder. In aspects, a stripping agent is used in the twin-screw extruder. In aspects, the stripping agent used in the twin-screw extruder is selected from the group consisting of: water, carbon dioxide, nitrogen, and a hydrocarbon gas. In aspects, the stripping agent used in the twin-screw extruder is selected from the group consisting of water and carbon dioxide. In aspects, the stripping agent used in the twin-screw extruder is water. In aspects, the stripping agent used in the twin-screw extruder is carbon dioxide. In aspects, the stripping agent used in the twin-screw extruder is nitrogen. In aspects, the stripping agent used in the twin-screw extruder is a hydrocarbon gas.

In aspects, the present disclosure is directed to a method of reducing taste and/or odor in a post-consumer recycled (PCR) resin-containing composition. the method comprising: combining a PCR resin comprising at least 50 wt. % polyolefin and an initial limonene level of at least 5 ppm with a virgin ethylene-based polymer, and an odor-active zeolite having an FAU crystal structure, an MFI crystal structure, and/or beta crystal structure and a Si/Al molar ratio from 1 to 100; and producing the PCR resin-containing composition having reduced taste and/or odor as well as a reduced initial limonene below 3 ppm by performing one or both of the following devolatilization steps: devolatilizing the PCR resin prior to the combining step; and devolatilizing the PCR-resin containing composition after the combining step, wherein the components are combined by compounding. As used herein, the term “compounding” refers to preparing plastic compositions by mixing and/or blending polymers and additives in a molten state to achieve the desired characteristics. In aspects, the compounding comprises screw extrusion, wherein a hopper feeds the begin of the screw, which gradually transports the resin/melt/solution towards the die, at which point an extrudate is produced. The extrudate may comprise long, plastic stands, which are optionally divided into pellets.

In embodiments, the present disclosure is directed to a method of reducing taste and/or odor in a post-consumer recycled (PCR) resin-containing composition, the method comprising: combining a PCR resin comprising at least 50 wt. % polyolefin and an initial limonene level of at least 5 ppm with a virgin ethylene-based polymer, and an odor-active zeolite having an FAU crystal structure, an MFI crystal structure, and/or beta crystal structure and a Si/Al molar ratio from 1 to 100; and producing the PCR resin-containing composition having reduced taste and/or odor as well as a reduced limonene below 3 ppm by performing one or both of the following devolatilization steps: devolatilizing the PCR resin prior to the combining step; and devolatilizing the PCR-resin containing composition after the combining step.

In embodiments, the present method involves devolatilizing the PCR resin prior to the combining step. This method comprises devolatilization of a PCR resin comprising at least 50 wt. % polyolefin and an initial limonene level of at least 5 ppm by itself. Once the PCR resin has been devolatilized, the devolatilized PCR resin is combined (e.g., by compounding) with a virgin ethylene-based polymer and at least one odor-active zeolite having an FAU crystal structure, an MFI crystal structure, and/or beta crystal structure and a Si/Al molar ratio from 1 to 100. As a result, a PCR resin-containing composition is produced that has a reduced taste and/or odor, as well as a reduced limonene level of below 3 ppm.

In embodiments, the present method involves devolatilizing the PCR-resin containing composition after the combining step. This method comprises combining of a PCR resin comprising at least 50 wt. % polyolefin and an initial limonene level of at least 5 ppm, a virgin ethylene-based polymer, and an odor-active zeolite having an FAU crystal structure, an MFI crystal structure, and/or a beta crystal structure and a Si/Al molar ratio from 1 to 100. In embodiments, the combining step is done by compounding the PCR resin, the virgin ethylene-based polymer, and the at least one odor-active zeolite. Next, the combined PCR resin, virgin ethylene-based polymer, and the at least one odor-active zeolite are devolatilized. As a result, a PCR resin-containing composition is produced that has a reduced taste and/or odor, as well as a reduced limonene level of below 3 ppm.

### EXAMPLES

The following examples illustrate features of the present disclosure but are not intended to limit the scope of the disclosure. The following experiments analyzed the performance of embodiments of compositions described herein.

### Compounding and Devolatilization Process:

Samples were compounded in an 11-barrel (44 L/D) Coperion ZSK-26 twin-screw extruder. Extrusion was performed at a screw speed of 200 rpm, a throughput of 20 lb/h and barrel and die temperature set point of 220° C. “No de-vo” indicates all components were compounded in a single step with no de-volatilization. “One-step de-vo” indicates vacuum was pulled while compounding all materials in a single step as described below. “Two-step de-vo” indicates that the KWR PCR was first run through the devolatilization process, and then compounded with the other components in a second step in the twin-screw extruder.

Devolatilization extrusion was performed on an 11-barrel (44 L/D) Coperion ZSK-26 twin-screw extruder. The extruder was set up with two devolatilization sections using water as stripping agent. Water was added at 2 wt. % of throughput of extruder per injector in barrels 4 and 7 by two ISCO pumps. Two vent ports on barrels 6 and 9 pulled vacuum to remove the stripping water and any volatiles. Extrusion was performed at a screw speed of 200 rpm. a throughput of 20 lb/h and barrel and die temperature set point of 220° C.

### Zeolite Measurements:

X-ray powder diffraction patterns (XRD) were acquired on powdered samples using a Bruker D4 diffractometer operated at 40 KV and 40 mA with divergence slits set at 0.20 mm and antiscattering slit set at 0.25 mm. The crystal structure of the zeolites were determined using x-ray diffraction and comparing the diffraction pattern to a public x-ray zeolite database (IZA Zeolite Structure Database).

The Si/Al molar ratio was analyzed using wavelength dispersive x-ray fluorescence under helium using semi-quantitative omnium analysis to calculate the element composition.

The grain size of the zeolites was measure using microscopy on a scanning electron microscope (SEM) and measuring the size distribution of the grains present.

The surface areas and pore volumes of the ABSCENTS materials were measured by nitrogen adsorption at 77.4 K using the conventional technique on a Micromeritics ASAP 2420 apparatus. Prior to the adsorption measurements, the samples were degassed in vacuum at 300° C. for at least 3 hours. The pore volumes were determined from the adsorption and desorption branch of isotherms using the Barret-Joyner-Halenda (BJH) procedure. The surface area was calculated using BET method. The Abscents 2000 zeolite has an Si/Al molar ratio of 6, a BET (Brunauer-Emmett-Teller) surface area of 455 m²/g, a pore volume of 0.29 cm³/g, a mixture of FAU and MFI crystal structures, and a grain size of ˜250 nm to 2 μm.

The Abscents 3000 zeolite has an Si/Al molar ratio of 650, a BET (Brunauer-Emmett-Teller) surface area of 344 m²/g, a pore volume of 0.18 cm³/g, an MFI crystal structure, and a grain size of ˜250 nm to 2 μm.

### Polymer Materials

TABLE 1

| | | Melt | | |
|---|---|---|---|---|
| | Component | Index | Density | |
| Product Name | Type | (g/10 mins) | (g/cc) | Supplier |
| KWR 101-150 | HDPE PCR | 0.60 | 0.960 | KW |
| (“KWR”) | | | | Plastics |
| CONTINUUM ™ | HDPE | 1.22 | 0.955 | Dow Inc. |
| DMDC-1250 NT 7 | | | | (Midland, |
| (“DMDC”) | | | | MI) |

KWR101-150 has an initial limonene level of 25 PPM.

### Example 1

The performance of various devolatilization techniques with varying amounts of Abscents 2000 and 3000 zeolites was evaluated in samples. The various samples used in these tests are displayed in Table 2. In this study, the amount of HDPE virgin resin and KWR PCR resin (by wt. %) were varied in the samples.

TABLE 2

| | HDPE | KWR | | | |
|---|---|---|---|---|---|
| | DMDC 1250 | PCR | ABSCENTS | ABSCENTS | |
| | Virgin Resin | Resin | 2000 | 3000 | De-vo |
| Sample | (wt %) | (wt %) | (wt %) | (wt %) | Process |
| Comp 1 | 70 | 30 | 0 | 0 | none |
| Comp 2 | 69.5 | 29.5 | 0 | 1 | none |
| Inv 3 | 69.5 | 29.5 | 1 | 0 | none |
| Comp 3 | 69.5 | 29.5 | 0.5 | 0.5 | none |
| Comp 4 | 70 | 30 | 0 | 0 | 2-step |
| Inv 5 | 69.5 | 29.5 | 0.5 | 0.5 | 2-step |
| Comp 5 | 69.5 | 29.5 | 0 | 1 | 2-step |
| Inv 7 | 69.5 | 29.5 | 1 | 0 | 2-step |
| Inv 8 | 69 | 29 | 1 | 1 | 2-step |
| Comp 6 | 69.9 | 29.9 | 0.1 | 0.1 | 2-step |
| Comp 7 | 70 | 30 | 0 | 0 | 1-step |
| Inv 10 | 69.725 | 29.725 | 0.55 | 0 | 1-step |
| Inv 11 | 69.725 | 29.725 | 0 | 0.55 | 1-step |
| Inv 12 | 69.725 | 29.725 | 0.275 | 0.275 | 1-step |
| Inv 13 | 69.725 | 29.725 | 0.11 | 0.44 | 1-step |
| Inv 14 | 69.725 | 29.725 | 0.05 | 0.5 | 1-step |
| Inv 15 | 69.725 | 29.725 | 0.1 | 0.1 | 1-step |

The percent reduction of oxygenates of interest (including certain aldehydes, ketones, and THF-derivatives), percent reduction of oxygenates of interest overall, percent reduction of limonene, and the level of limonene in ppm of the processed samples were determined, and are displayed in Table 3. The limonene content of the samples were characterized and compared by weighing 0.05 g of sample into a headspace vial, heating to 190° C. for 60 minutes, and measured using gas chromatography. The oxygenate content of the samples was characterized by heating the sample to 100° C. to thermally desorb odorous oxygenates, followed by analysis with comprehensive two-dimensional gas chromatography coupled with a mass spectrometer.

TABLE 3

| | | | THF | Average | | |
|---|---|---|---|---|---|---|
| | Aldehyde | Ketone | Derivative | Oxygenate | Limonene | Limonene |
| Sample | (% reduction) | (% reduction) | (% reduction) | Reduction | (% Reduction) | (ppm) |
| Comp 1 | 0 | 0 | 0 | 0 | 0 | 8 |
| Comp 2 | 98 | 100 | 81 | 93 | 0 | 8 |
| Inv 3 | 93 | 100 | 100 | 98 | 87.5 | 1 |
| Comp 3 | 53.8 | 100 | 40.4 | 64 | 37.5 | 5 |
| Comp 4 | 71% | 100% | 58% | 76 | 75 | 2 |
| Inv 5 | 81.7 | 100 | 53% | 78 | >90 | <1 |
| Comp 5 | 100 | 100 | 58% | 86 | 75 | 2 |
| Inv 7 | 82% | 100 | 100% | 94 | >90 | <1 |
| Inv 8 | 100% | 100 | 100 | 100 | >90 | <1 |
| Comp 6 | 64% | 100 | 14% | 60 | 87.5 | 1 |
| Comp 7 | 53 | 100% | 100% | 84 | 75 | 2 |
| Inv 10 | 87 | 100 | 100% | 96 | >90 | <1 |
| Inv 11 | 98 | 100 | 100% | 100 | 87.5 | 1 |
| Inv 12 | 97 | 100% | 100% | 99 | >90 | <1 |
| Inv 13 | 98 | 100 | 100% | 100 | >90 | <1 |
| Inv 14 | 95 | 100 | 100% | 98 | 87.5 | 1 |
| Inv 15 | 92 | 100 | 100% | 97 | 87.5 | 1 |

### Example 2

To determine the type of zeolites effective for odor removal, a series of additional experiments was performed. Powder samples of zeolites were dosed in a vial with a set of model compounds including limonene and propanal. The removal efficiencies at 75° C. were determined by headspace gas chromatography. The results are displayed in Table 4.

TABLE 4

| | Si/Al | Crystal | | Limonene | Oxygenate Uptake |
|---|---|---|---|---|---|
| Zeolites | ratio | Structure | Grain Size (SEM) | Uptake | (Propanal) |
| ABS 2000 | 6 | FAU/MFI | ~250 nm to 2 μm | >90% | >90% |
| ABS 3000 | 650 | MFI | ~250 nm to 2 μm | <90% | >90% |
| CBV 400 | 5 | Beta | ~150 nm to 1 μm | >90% | >90% |
| CBV 901 | 80 | Beta | ~150 nm to 1 μm | >90% | >90% |
| Strukol RP 59 | 18 | not a zeolite | ~5 μm to 70 μm | <90% | <90% |
| Comparative | 25 | MFI | 30 nm-100 nm | <90% | <90% |
| zeolite 1 | | | | | |
| (CP764) | | | | | |
| CBV 15014G | 150 | MFI | 30-100 nm | <90% | >90% |
| ZD12041 | 400 | MFI | 30 nm-100 nm | <90% | >90% |
| Bentonite | 5 | TOT | ~5 μm to 20 μm | <90% | <90% |

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A composition comprising:
post-consumer recycled (PCR) resin comprising at least 50 wt. % polyolefin, the PCR resin having an initial limonene level of at least 5 ppm;
virgin ethylene-based polymer; and
at least one odor-active zeolite, wherein the odor-active zeolite has an FAU crystal structure, an MFI crystal structure, and/or a beta crystal structure and a Si/Al molar ratio from 1 to 100,
wherein the composition has a reduced limonene level of less than 3 ppm.

2. The composition of claim 1, wherein the polyolefin of the PCR resin is polyethylene.

3. The composition of claim 1, wherein the composition comprises from 0.025 wt. % to 2.0 wt. % of the at least one odor-active zeolite.

4. The composition of claim 1, wherein the virgin ethylene-based polymer comprises high-density polyethylene (HDPE) having a density from 0.940 g/cc to 0.975 g/cc.

5. The composition of claim 1, wherein the PCR resin comprises a high-density polyethylene (HDPE)-based PCR resin having a density from 0.940 g/cc to 0.970 g/cc.

6. The composition of claim 1, wherein the composition comprises from 15 wt. % to 95 wt. % of the PCR resin

7. The composition of claim 1, wherein the composition comprises from 1 wt. % to 85 wt. % of the virgin ethylene-based polymer.

8. The composition of claim 1, wherein the at least one odor-active zeolite has a grain size of 250 nm to 2 μm.

9. The composition of claim 1, wherein the Si/Al molar ratio of the at least one odor-active zeolite is from 1 to 50.

10. The composition of claim 1, wherein the composition has a reduced limonene level of less than 1 ppm.

11. A product comprising the composition of claim 1, wherein the product comprises a cap or a closure.

12. A film comprising the composition of claim 1, wherein the film is a monolayer film or multilayer film.

13. A method of reducing taste and odor in a post-consumer recycled (PCR) resin-containing composition, the method comprising:
combining a PCR resin comprising at least 50 wt. % polyolefin and an initial limonene level of at least 5 ppm with a virgin ethylene-based polymer, and an odor-active zeolite having an FAU crystal structure, an MFI crystal structure, and/or a beta crystal structure and a Si/Al molar ratio from 1 to 100; and
producing the PCR resin-containing composition having reduced taste and odor as well as a reduced limonene level below 3 ppm by performing one or both of the following devolatilization steps:
devolatilizing the PCR resin prior to the combining step; and
devolatilizing the PCR resin-containing composition after the combining step.

14. The method of claim 13, wherein the virgin ethylene-based polymer comprises high-density polyethylene (HDPE) having a density from 0.940 g/cc to 0.975 g/cc.

15. The method of claim 13, wherein the composition comprises from 15 wt. % to 95 wt. % of the PCR resin, 1 wt. % to 85 wt. % of the virgin ethylene-based polymer, and from 0.025 wt. % to 2.0 wt. % of the at least one odor-active zeolite.

16. The method of claim 13, wherein the devolatilization is performed on a twin-screw extruder, and a stripping agent is used in the twin-screw extruder, wherein the stripping agent is selected from the group consisting of: water, carbon dioxide, nitrogen, and a hydrocarbon gas.

17. The method of claim 13, wherein the PCR resin-containing composition has an oxygenates reduction by at least 75% relative to the initial PCR resin.

18. The method of claim 13, wherein the PCR resin-containing composition has a reduced limonene level below 1 ppm.
